(19) United States
(12) Patent Application Publication
(10) Pub. No.: US 2021/0248735 A1
(43) Pub. Date: Aug. 12, 2021

(54) ARRANGEMENT AND METHOD FOR IDENTIFYING AND TRACKING LOGS

(71) Applicant: TRACY OF SWEDEN AB, Virserum (SE)

(72) Inventors: Jonny EDVARDSSON, Virserum (SE); Jan-Erik RENDAHL, Stockholm (SE)

(21) Appl. No.: 17/055,625

(22) PCT Filed: May 15, 2019
(86) PCT No.: PCT/IB2019/054003

§ 371 Date: Nov. 16, 2020

(30) Foreign Application Priority Data
May 16, 2018 (SE) 1830162-2

(51) Int. Cl. G06T 7/00; G06T 7/11; G06T 7/80; G06F 16/58; G06F 16/587; A01G 23/00

(52) U.S. Cl. CPC G06T 7/0004; G06T 7/11; G06T 7/80; G06T 2207/10004; G06F 16/587; A01G 23/003; G06T 2207/30188; G06F 16/5866

(57) ABSTRACT

There is disclosed an arrangement for identifying and tracking a log. The arrangement comprises at least one imaging device that, when in operation, captures at least one image of the log, a Global Positioning System (GPS) receiver that, when in operation, determines a felling location of the log, a remote server arrangement that, when in operation, receives data related to captured at least one image and the determined felling location of the log, and processes the received data to create an identification information for the log, and a data processor that, when in operation, checks if a query matches with the identification information in the remote server arrangement, and retrieves identification information corresponding to the matched query.

### TECHNICAL FIELD

The present disclosure relates to arrangements for use in timber industries.

Furthermore, the present disclosure also relates to methods of implementing aforementioned arrangements. Moreover, the present disclosure also relates to using aforementioned arrangements and methods in timber industries.

### BACKGROUND

Wood is the primary material for the forest product industry from which many high-demand products are made. The forest products industry can be broken down into a number of possible processing operations, namely logging, primary processing, and secondary processing. Logging involves cutting trees and turning them into logs, primary processing involves turning logs into products, such as lumber, plywood, veneers and the likes, and secondary processing involves turning the products created by primary manufacturers into products that are typically sold to end users, such as doors, windows, furniture, household fixtures and the likes.

However, the conventional processing operations used by the forest product industry include a number of problems. One of such problems involved in the conventional processing operations is tracing a piece of log back to a geographical location regarding its fell place. Generally, the conventional processing operations include spraying or imprinting the log, while logging or primary processing, with the identification code or symbol for tracking an origin of the given log. This technique is inherently flawed, as the conventional processing operations include little or no measures to avoid manipulation of the imprinted identification code on the log.

Therefore, such imprinted identification code on the log can be easily altered. For example, such identification code can be scraped off the log and re-sprayed or re-imprinted. Another problem involved in the conventional processing operations is that the processing operations include a lot of human intervention. Therefore, such technique is time consuming, inefficient, and cumbersome to be executed. Furthermore, such technique is also susceptible to fallacious information.

Therefore, in light of the foregoing discussion, there exists a need to overcome the aforementioned drawbacks associated with the conventional processing operations used by the forest product industry.

### SUMMARY

The present disclosure seeks to provide an improved arrangement for identification and tracking of a log.

The present disclosure also seeks to provide an improved method for identifying and tracking a log.

In a first aspect, an embodiment of the present disclosure provides an arrangement for identifying and tracking a log, the arrangement comprising:
at least one imaging device operable to capture at least one image of the log and at least one image of a stump of a felled tree;
a Global Positioning System (GPS) receiver operable to determine a felling location of the log;
a remote server arrangement operable to receive data related to captured at least one image of the log, the at least one image of the stump and the determined felling location of the log, and process the received data to create an identification information for the log; and
a data processor that is operable to check if a queried image matches with the identification information in the remote server arrangement, and retrieve identification information corresponding to the matched queried image , wherein the data processor is operable to:
determine if a quality of the queried image exceeds a quality of the matched image; and
replace the captured at least one image with the queried image, if the quality of the queried image exceeds the quality of the matched image

The present disclosure is of the advantage that it provides at least a partial solution to a problem of identifying and tracking a log, wherein identifying a log primarily includes capturing images of end face of the log and stump of the tree from which the log is created; and tracking the log includes comparing an image with the image of the end face of the log; and furthermore the identification and tracking of the log is made more accurate or efficient by associating parameters, described herein later.

Optionally, the data processor is operable to check if a queried image matches with the captured at least one image in the remote server arrangement, and to retrieve identification information corresponding to the matched image.

Optionally, the arrangement further comprises at least one input arrangement (namely input means) operable to enter metadata about the log, wherein the remote server arrangement is operable to associate the entered metadata with the identification information for the log.

Optionally, the entered metadata includes one or more of felling area's owner information, felling contractor company's information, log buyer information and log receiver information.

Optionally, the arrangement further comprises at least one sensor operable to measure at least a weight or a length of the log, wherein the remote server arrangement is operable to associate the measured at least weight or the length with the identification information for the log.

Optionally, the arrangement further comprises a communication module operable to transmit data related to the captured at least one image and the determined felling location of the log to the remote server arrangement.

Optionally, the at least one image comprises an image of one or more end faces of the log.

Optionally, the at least one imaging device comprises a smartphone camera.

Optionally, the at least one imaging device comprises a camera mounted on a forest harvester.

Optionally, the at least one imaging device comprises a microwave imaging device.

Optionally, the at least one imaging device comprises a tilt orientation support module operable to acquire calibration information of the least one imaging device with respect to a planar surface of the log, and construct a corrected image of the log using the calibration information.

Optionally, the at least one imaging device comprises a zooming support module operable to zoom on an end face of the log for capturing at least one image thereof.

Optionally, the at least one imaging device comprises an image checking module operable to check if quality of the at least one image is below predefined parameters. More optionally, the at least one imaging device comprises a first image correction module operable to generate a signal to indicate to a user to capture at least one new image of the log, if quality of the at least one image is below predefined parameters, and replace the at least one image of the log with the at least one new image of the log. More optionally, the at least one imaging device comprises a second image correction module operable to determine if one or more other images of the log are available, and combine one or more other images of the log with the at least one image of the log to generate a corrected image of the log.

In a second aspect, an embodiment of the present disclosure provides a method for (of) identifying and tracking a log, the method comprising:
capturing at least one image of the log and at least one image of a stump of a felled tree;
determining a felling location of the log;
processing data related to the captured at least one image of the log, the at least one image of the stump and the determined felling location of the log to create an identification information for the log;
checking if a queried image matches with the identification information; and
retrieving identification information corresponding to the matched queried image, wherein the step of checking a queried image comprising:
determining if quality of the queried image exceeds quality of the matched image; and
replacing the captured at least one image with the queried image, if quality of the queried image exceeds quality of the matched image.

Optionally, the method further comprises checking if a queried image matches with the captured at least one image and retrieving identification information corresponding to the matched image.

Optionally, the method further comprises receiving metadata about the log, and associating the received metadata with the identification information for the log.

Optionally, the method further comprises measuring at least a weight or a length of the log, and associating the measured at least weight or the length with the identification information for the log.

Optionally, the at least one image comprises an image of one or more end faces of the log.

Optionally, the method further comprises acquiring calibration information of an imaging device used for capturing at least one image of the log with respect to a planar surface of the log, and constructing a corrected image of the log using the calibration information.

Optionally, the method further comprises zooming on an end face of the log for capturing at least one image thereof.

Optionally, the method further comprises checking if quality of the at least one image is below predefined parameters. More optionally, the method further comprises generating a signal to indicate to a user to capture at least one new image of the log, if quality of the at least one image is below predefined parameters, and replacing the at least one image of the log with the at least one new image of the log. More optionally, the method further comprises determining if one or more other images of the log are available, and combining one or more other images of the log with the at least one image of the log to generate a corrected image of the log.

In a third aspect, an embodiment of the present disclosure provides a computer readable medium containing program instructions for execution on a computer system, which when executed by a computer, cause the computer to perform method steps of (for) a method for identifying and tracking a log, the method comprising:
capturing at least one image of the log and at least one image of a stump of a felled tree;
determining a felling location of the log;
processing data related to captured at least one image of the log, the at least one image of the stump and the determined felling location of the log to create an identification information for the log;
checking if a queried image matches with the identification information; and
retrieving identification information corresponding to the matched queried image, wherein the step of checking a queried image comprises:
determining if quality of the queried image exceeds quality of the matched image; and
replacing the captured at least one image with the queried image, if quality of the queried image exceeds quality of the matched image.

The arrangement and method enables the identification and tracking of a log. The arrangement is operable to manage identification information for the log. The described arrangement, methods and system create and store accurate identification information for logs and also include provisions for authentication thereof. Therefore, authentication of logs is thereby highly accurate and key players within the timber industry value chain can efficiently trace origin of logs to felling locations thereof. Furthermore, the described arrangement is operable to seamlessly update the identification information for logs. For example, the image used for the identification of the log is updated if a better quality image of the log is available later in the value chain. Therefore, the arrangement is constantly optimized, and thereby is capable of operating efficiently. Moreover, the information related to the log are digitally generated and stored. Therefore, the arrangement is inherently free of errors generally involved in manual processing. Moreover, the arrangement can be used to re-identify log at a later stage of value chain of the log, such as, during storage or processing thereof. Such re-identification of the log enables improved management (such as storage, use and so forth) and traceability through the entire value chain of the log.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of an arrangement for identification and tracking of a log, in accordance with an embodiment of the present disclosure;

FIGS. 2A-2D are schematic illustrations of exemplary graphical user interfaces for implementing the arrangement of FIG. 1 for identifying the log, in accordance with an embodiment of the present disclosure;

FIGS. 3A-3B are schematic illustrations of exemplary graphical user interfaces for implementing the arrangement of FIG. 1 for tracking the log, in accordance with an embodiment of the present disclosure; and

FIG. 4 is an illustration of steps of a method of identification and tracking of a log, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides an arrangement for identifying and tracking a log, the arrangement comprising:
at least one imaging device operable to capture at least one image of the log and at least one image of a stump of a felled tree;
a Global Positioning System (GPS) receiver operable to determine a felling location of the log;
a remote server arrangement operable to receive data related to the captured at least one image of the log, the at least one image of the stump and the determined felling location of the log, and process the received data to create an identification information for the log; and
a data processor that is operable to check if a queried image matches with the identification information in the remote server arrangement, and retrieve identification information corresponding to the matched queried image, wherein the data processor (110) is operable to:
determine if quality of the queried image exceeds quality of the matched image; and
replace the captured at least one image with the queried image, if quality of the queried image exceeds quality of the matched image.

In a second aspect, an embodiment of the present disclosure provides a method for (of) identifying and tracking a log, the method comprising:
capturing at least one image of the log and at least one image of a stump of a felled tree;
determining a felling location of the log;
processing data related to the captured at least one image of the log, the at least one image of the stump and the determined felling location of the log to create an identification information for the log;
checking if a queried image matches with the identification information; and
retrieving identification information corresponding to the matched queried image

wherein the step of checking a queried image comprises:
determining if quality of the queried image exceeds quality of the matched image; and
replacing the captured at least one image with the queried image, if quality of the queried image exceeds quality of the matched image.

The present disclosure provides the arrangement for identifying and tracking the log. The arrangement relates to a structure including one or more programmable and/or non-programmable components that are configured to perform one or more steps to identify and track log. Furthermore, the one or more programmable and/or non-programmable components are interconnected therein. Moreover, the one or more programmable and/or non-programmable components are operable to form a computing environment, which enables the arrangement to operate as a digital system for identifying and tracking a log. Throughout the present disclosure, the term “log” relates to any type of elongated, wooden material created from a tree. Specifically, the log is a piece of wood that is formed when a tree is cut to fall. Examples of log include timber or wooden block and the likes, having a variety of sizes, identification marks, weights and lengths. Moreover, the portion of the tree that remains attached to ground (after the being harvested to form the log) are referred to herein as stump of felled tree. Additionally, the arrangement allows seamless identification of the tree log. Moreover, the identification information (described herein later) of the log can be used for managing the log in a value chain of the tree log. Throughout the present disclosure, the term “identification” relates to a process in which, and means by which, the identity of the log is determined and verified one or more times in the value chain of the tree log. Furthermore, throughout the present disclosure, the term “tracking” relates to a process in which, and means by which, a location associated with the log can be recognized one or more times in the value chain of the tree log.

The arrangement comprises the at least one imaging device operable to capture the at least one image of the log. Throughout the present disclosure, the term “at least one imaging device” relates to a device that includes at least one lens and image sensor to acquire a reflectance from a reflected visible light that is reflected from the planar surface (namely an end face) of the log. Optionally, the at least one imaging device includes a body housing, an electronic circuit, a photographic objective mounted on the body, and a connecting device (such as Universal Serial Bus device) operatively coupled to the electronic circuit for establishing data communication. In an example, the at least one imaging device is implemented using a uEye LE USB 3.1 Gen. 1 camera. Furthermore, the imaging device is operable to capture the least one image of the log via the photographic objective and thereafter store the captured image in a storage component included in the electronic circuit.

Optionally, the at least one imaging device comprises a smartphone camera. Specifically, the at least one imaging device can be a built-in camera within a smartphone. For example, the least one imaging device is a digital camera of the smartphone. Furthermore, the smartphone may include physical and virtual element, namely a button that enables capturing images of the log. In such example, the image captured by the digital camera may be stored in the storage component of the smartphone. Optionally, the at least one imaging device comprises a camera mounted on a forest harvester. Optionally, the at least one imaging device, namely the camera can be mounted on the forest harvester that is used to harvest a tree and thereby create the tree log. Furthermore, the at least one imaging device is mounted in the forest harvester in a manner such that the imaging device is capable of capturing a view of the tree log. Moreover, the at least one imaging device is mounted on the forest harvester using a hinge arrangement. Furthermore, the hinge member enables both single and/or multiple degrees of freedom of movement to the least one imaging device. Subsequently, such arrangement enables the at least one imaging device mounted on the forest harvester to capture the one or more image of the log. Optionally, the at least one imaging device comprises a microwave imaging device. Optionally, the at least one imaging device, namely the microwave imaging device, can be communicably coupled to a smartphone or a forest harvester. Optionally, the microwave imaging device can be a portable device. For example, the microwave imaging device includes a scan circuit, a reception circuit and an image generator that are operable to capture the one or more image of the log and/or the stump of felled tree. Furthermore, the microwave imaging device can be a movable device or can be permanently attached to the forest harvester.

Furthermore, throughout the present disclosure, the term “at least one image” relates to any pattern of optical contrast produced on the inside the at least one imaging device that has a similar appearance to an object, namely a stump of a tree, a log or end faces of the log. Specifically, the at least one image is a digital image. Therefore, the pattern of optical contrast produced inside the at least one imaging device is a set of digital information and an optical image of the stump of a tree, a log or end faces of the log, that is produced in the at least one imaging device, namely the smartphone camera or the camera mounted on a forest harvester, using that set of digital information. Optionally, the image can have a two-dimensional or three-dimensional appearance.

Optionally, the at least one image comprises an image of stump of felled tree. Specifically, the at least one imaging device, namely a smartphone camera or a camera mounted on a forest harvester, is operable to capture the image of the stump of felled tree. In an example, the camera of the smartphone may be used to capture the image of the stump of felled tree. In another example, the image of the stump of felled tree may be captured by the camera mounted on the forest harvester used to harvest the tree. Optionally, the image of stump includes one or more unique identification marks that can be used to identify the stump. In an example, the one or more unique identification marks may be the annular rings that are formed in the stump.

Optionally, the at least one image comprises an image of one or more end faces of the log. Throughout the present disclosure, the term “end face of the log” refers to a planner surface that is formed in the end portion of the log formed upon harvesting the tree. Furthermore, the planner surface of the end portion of the log includes one or more identification marks, namely annular rings. Moreover, the at least one imaging device can be used to capture an image of one or more end faces of the log. In an example, the smart phone can be used to capture the image of the one or more end faces of the log. In another example, the image of one or more end faces of the log may be captured by the camera mounted on the forest harvester used to harvest the tree.

Optionally, the at least one imaging device comprises a tilt orientation support module operable to acquire calibration information of the least one imaging device with respect to a planar surface of the log. Throughout the present disclosure, the term “tilt orientation support module” relates to a collection or set of instructions executable by digital system so as to configure the digital system to perform a specific task. Specifically, the digital system, namely the electronic circuit of the at least one imaging device, includes the set of instructions for acquiring calibration information of the least one imaging device. In an example, the calibration information of the at least one imaging device comprises at least one of position of the at least one imaging device with respect to the stump of felled tree and/or end face of the log, such as a distance, an angular orientation and so forth.

Optionally, the calibration information may also comprise functional parameters of the at least one imaging device, including but not limited to, power of a lens used in the imaging device, a lens distortion function of the lens used in the imaging device, a standard resolution of the images captured by the imaging device and so forth. Optionally, the set of instructions is operable to determine the degree of angular orientation associated with the at least one imaging device with respect to the end face of the log, while capturing the at least one image of the log. For example, the set of instructions in the at least one imaging device determines information that describes how many degrees from 90° to the end face of the log the at least one imaging device is held while capturing the at least one image. Alternatively, the information that describes amount of degree at which the at least one imaging device is held while capturing the at least one image may be sent to the remote server arrangement (explained herein) to change an orientation of the captured at least one image. Optionally, the information that describes amount of degree at which the at least one imaging device is held while capturing the at least one image can be used to determine the position of the at least one imaging device while capturing the at least one image of the log. For example, a graphical indication may be displayed in the display of the smartphone camera to suggest an accurate position for holding the smartphone camera. Furthermore, the graphical indication may exhibit change in colour to identify if the smartphone camera is held at an accurate position. In another example, suggestion may be provided to adjust the position of the camera mounted on a forest harvester to attain the accurate position for capturing the at least one image of the log. In such example, the suggestion may be a visual indication provided via a light source attached to the forest harvester.

Optionally, the tilt orientation support module is operable to construct a corrected image of the log using the calibration information. Specifically, tilt orientation support module includes an algorithm that is configured to use the information that describes the amount of degree at which the at least one imaging device is held while capturing the at least one image to change an orientation of the captured at least one image, and thereafter construct a corrected image of the log using the calibration information. In an example, the algorithm of the tilt orientation support module may include a predefined set of information that describes the angular orientation required for capturing an accurate at least one image of the log. Therefore, the algorithm may use predefined set of information and the information that describes the amount of degree at which the at least one imaging device is to be held to determine specific parameters or measurements for changing pixel coordinates for capturing the at least one image and thereby construct the corrected image of the log.

Optionally, the at least one imaging device comprises a zooming support module operable to zoom on an end face of the log for capturing at least one image thereof. The zooming support module includes a set of information, executed in the electronic circuit of the at least one imaging device, to provide an indication about a mode of capturing the at least one image of the end face of the log in an enlarged form. The modes of capturing the at least one image of the end face of the log include the landscape mode and the portrait mode. Furthermore, in the landscape and portrait mode of capturing the at least one image of the end face of the log, includes the indication, namely a circular boundary, provided in the display of the at least one imaging device, wherein the end face of the log may be virtually positioned within while capturing the at least one image of the end face of the log. Optionally, the circular boundary enables capturing of enlarged image of the stump of felled tree and/or the one or more end faces of the log. Furthermore, the enlarged image of the stump of felled tree and/or the one or more end faces of the log captured within the circular boundary includes clear view of the unique identification marks namely the annular rings formed on the stump of felled tree and/or the one or more end faces. Beneficially, zooming support module enables to enhance the accuracy while capturing the at least one image that may be used for the identification of the log, and thereby increase the efficiency of the arrangement. Optionally, the landscape mode may be used while the imaging device is positioned at a larger distance from the end face of the log and the portrait mode may be used while the imaging device is positioned close to the end face of the log. Optionally, the modes of capturing the at least one image may be manually and/or automatically changed by rotating the orientation of holding the at least one imaging device.

Optionally, the at least one imaging device comprises an image checking module operable to check if quality of the at least one image is below predefined parameters. The image checking module may include one or more algorithms to determine the quality of the at least one image captured by the at least one imaging device. Furthermore, the one or more algorithms will be configured to implement blur estimation techniques, namely edge analysis and/or frequency analysis of the at least one image captured by the at least one imaging device. Moreover, the one or more algorithms will be configured to implement blur estimation techniques that may include predefined parameters, namely predefined blur values of an image that is accurate for the arrangement. Furthermore, the one or more algorithms will determine blur values of the at least one image captured by the at least one imaging device and compare with the predefined blur values, and thereafter determine if quality of the at least one image is below predefined parameters. For example, the predefined blur value is X and the determined blur values of the at least one image may be Y. In such example, the one or more algorithms may analyze the numerical value associated with X and Y and thereafter determine that the numerical value associated with X is less than the numerical value associated with Y. Consequently, the image checking module may determine that the quality of the at least one image is below predefined parameters.

Optionally, the at least one imaging device comprises a first image correction module operable to generate a signal to indicate to a user to capture at least one new image of the log, if quality of the at least one image is below predefined parameters. Specifically, the first image correction module is a logical module including one or more instruction executable on the electronic circuit of the at least one imaging device, and is operable to generate the signal to indicate to a user. In an example, the first image correction module may be operable to generate a notification message to be displayed in the at least one imaging device, namely the smartphone camera, to capture at least one new image of the log, if quality of the at least one image is below predefined parameters. In another example, the first image correction module may be operable to generate indication, namely a visual signal, in a device controlling the camera mounted on a forest harvester to identify capturing of a new at least one new image of the log, if quality of the at least one image is below predefined parameters. Furthermore, the first image correction module may be configured to check if the quality of the captured at least one new image of the log is below predefined parameters. Furthermore, if the quality of the at least one image is below predefined parameters, the first image correction module is operable to generate signal to indicate user to capture another at least one new image of the log. It will be appreciated that the term ‘user’ as used herein relates to any entity including a person (i.e., human being) or a virtual personal assistant (an autonomous program or a bot) using the device (such as the at least one imaging device) and/or arrangement described herein. Optionally, the first image correction module is operable to replace the at least one image of the log with the at least one new image of the log. Furthermore, the first image correction module includes a set on instruction to replace the at least one image of the log with the at least one new image of the log, in the event wherein the quality of the at least one new image is above the predefined parameters. For example, the predefined blur values X and the determined blur values of the at least one new image may be Y. In such example, the one or more algorithms may determine that the numerical value associated with Y is more than the numerical value associated with X. In such example, the first image correction module may instruct the user to capture at least one new image of the log, when the blur value associated with the at least one new image “Z” is lesser than X. In such example, the first image correction module may replace the at least one image of the log with the at least one new image of the log.

Alternatively, optionally, the at least one imaging device comprises a second image correction module operable to determine if one or more other images of the log are available. Specifically, the second image correction module is operable in the event wherein the quality of the at least one image is below predefined parameters. Furthermore, in such event second image correction module determines if one or more other images of the log are available. Optionally, the second image correction module includes collection or set of instructions that are configured to check if one or more other images of the log are available. Specifically, the collection or set of instructions is configured to determine if the at least one imaging device had captured one or more other images of the log. It may be appreciated that the one or more other images of the log refer to the additional image of the one or more end faces of the log other than the image of one or more end faces of the log that was initially captured by the at least one imaging device, namely the smartphone camera, camera mounted on a forest harvester, or the microwave imaging device. Optionally, the second image correction module may be operable to check a storage unit associated with the at least one imaging device, to determine if one or more other images of the log are available. Optionally, the second image correction module is operable to combine one or more other images of the log with the at least one image of the log to generate a corrected image of the log. In an example, the image correction module may include one or more algorithms that may be operable to merge the one or more other images of the log with the at least one image of the log to generate a corrected image of the log. In such example, the one or more algorithms that may be operable to supper-impose the one or more other images of the log on the at least one image of the log and thereby generate the corrected image of the log.

The arrangement comprises the Global Positioning System (GPS) receiver operable to determine a felling location of the log. Throughout the present disclosure, the term “Global Positioning System (GPS) receiver” relates to an electronic device that is capable of performing a specific task of acquiring a geographical location. Specifically, the Global Positioning System (GPS) receiver is associated with the least one imaging device that captures the at least one image of the log. Optionally, the Global Positioning System (GPS) receiver is operable to determine a felling location of the log; GPS is based upon using signals emitted from a plurality of orbiting satellites. Optionally, the GPS receiver includes a GPRS receiver that is operable to determine position based upon wireless emissions of a cellular mobile telephone infrastructure. Optionally, the GPS receiver may be a separate GPS receiver coupled to the forest harvester and/or the smartphone camera. Optionally, the Global Positioning System (GPS) receiver can be implemented as location sensor. For example, the location sensor may be included in the at least one imaging device, namely the smartphone camera or the camera mounted on the forest harvester. Furthermore, in an example, the location sensor can be implemented as GLONASS, IRNSS, Galileo, Beidou and the like.

Optionally, the felling location of the log may include a geographical location, such as geographical coordinates of the felling location (or site). For example, the felling location of a log may be associated with a geographical location (or geographical coordinates) of the forest harvester, while harvesting or cutting the log occurs in operation. Therefore, the felling location for different logs changes with geographical locations of the forest harvester, while harvesting or cutting such logs. Furthermore, the Global Positioning System (GPS) receiver is operable to receive the geographical location, and thereafter associate the at least one image of the log, namely the image of stump of felled tree and/or the image of one or more end faces of the log with the received the geographical location.

Optionally, the arrangement further comprises at least one input means operable to enter metadata about the log. Optionally, the at least one imaging device can include the at least one input means operable to enter metadata about the log. Optionally, the at least one imaging device can be a user interface. Throughout the present disclosure, the term “user interface (UI)” relates to a structured set of user interface elements rendered on a display screen associated to the at least one imaging device, such as the display associated to the smartphone camera or a peripheral display associated to the camera mounted on a forest harvester. Optionally, the user interface (UI) rendered on the display screen is generated by any collection or set of instructions executable by an associated arrangement. Additionally, the user interface (UI) is operable to interact with the user to convey graphical and/or textual information and receive input from the user. Specifically, the user interface (UI) used herein is a graphical user interface (GUI). Furthermore, the user interface (UI) elements refer to visual objects that have a size and position in user interface (UI). A user interface element may generally be visible, though there may be times when a user interface element is hidden. A user interface control is considered to be a user interface element. Text blocks, labels, text boxes, list boxes, lines, and images windows, dialog boxes, frames, panels, menus, buttons, icons, etc. are examples of user interface elements. In addition to size and position, a user interface element may have other properties, such as a margin, spacing, or the like. Furthermore, the metadata about the log refers to the additional information related to the log that will be manually provided via the at least one input means, namely the user interface.

Optionally, the entered metadata includes one or more of felling area's owner information, felling contractor company's information, log buyer information and log receiver information. In an example, the one or more of felling area's owner information may include the personal details of the owner, such as name, age, date of birth, permanent address, bank account number and the like. In another example, the felling contractor company's information may include the name of the company, location of the company office, services provided by the company, government registration of the company and the likes. In yet another example, the log buyer may be an individual, such as log transporting executive, that acquired the log from the felling contractor company. In such example, the log buyer information may include such name of the log buyer, age of the log buyer, date of birth of the log buyer, permanent address of the log buyer, bank account number of the log buyer and the like. In yet another example, the log receiver may be an individual, such as a sawmill representative, that acquired the log from the log buyer. In such example, the log receiver information may be name of the log receiver, age of the log receiver, date of birth of the log receiver, permanent address of the log receiver, bank account number of the log receiver and the like. In an example, the one or more of felling area's owner information may be used by the owner to register with the arrangement (namely the digital system) using the user interface for accessing the identification and tracking information of the log. Similarly, the log buyer information may be used by the log buyer and the log receiver information may be used by the log receiver to register with the arrangement for accessing the identification and tracking information of the log.

Optionally, the metadata including one or more of the felling area's owner information, the felling contractor company's information, the log buyer information and the log receiver information can be stored in an order number associated with buying of the log by the log buyer. For example, the order number can be a numerical value, an alphanumeric string of characters, and so forth that the metadata is associated thereto. In such an example, the arrangement (such as a smartphone) associated with a user (such as the felling area's owner, the felling contractor, the log buyer or the log receiver) presents a user interface for allowing input of the order number. After such an input of the order number into the user interface, the metadata including one or more of the felling area's owner information, the felling contractor company's information, the log buyer information and the log receiver information is provided to the user. Optionally, such order numbers associated with a plurality of orders are stored in a database. For example, the database corresponds to a regional authority (such as a national authority) responsible for regulation of timber trading within a region. In such an example, the order number represents a geographical felling area or region, within which trees are allowed to be felled. Information of all logs felled within this area, such as, within a given period of time (for example, a day, a week, a month, a year and so forth) will be connected to the order number. Optionally, all logs connected to the order number are numbered sequentially. In such an instance, numbers associated with the felled logs within the area in the given period of time are stored with corresponding order numbers within the database. Furthermore, the arrangement can be communicably coupled to the database and consequently, the arrangement can retrieve the metadata about the log from the database.

Optionally, the metadata about each felled log comprises a tag number, wherein the tag number is associated with GPS coordinates of the felling location of the felled log or location of stump of felled tree. For example, the GPS coordinates of the felling location of the log and/or the location of the stump of the felled tree is determined using the GPS receiver of the arrangement. Thereafter, such GPS coordinates are associated to the tag number of the felled tree, wherein the tag number can be a serial number, a random number or a pseudo-random number.

Optionally, the arrangement further comprises at least one sensor operable to measure at least a weight or a length of the log. In an example, the arrangement may include a weight sensor operable to measure at least a weight of the log, and a laser distance sensor operable to measure at least a length of the log. In such example, the weight sensor and the laser distance sensor may be attached to the at least one imaging device or to the forest harvester. Furthermore, the weight or the length of the log may be entered as the metadata about the log via the user interface. Optionally, the metadata about the log comprises a type of wood associated with the log and/or a quality of the log. It will be appreciated that the felled trees within a region can correspond to different types of wood, such as pine, birch, maple, spruce, ash, walnut, mahogany and so forth. Furthermore, the felled logs may be of different wood qualities, such as, based on an age of the log, a grain of the log, a colour of the log, a texture of the log, log defects (for example, knots, burls and so forth) and the like. In such instances, the metadata about the type of wood associated with the log and the quality of the log are stored with the metadata about the log. Optionally, the information about the log can be directly received from the sensor. Optionally, the metadata about the log provided to the at least one imaging device via the user interface is communicated to the remote server arrangement (explained herein later) using a communication module associated to the at least one imaging device.

Optionally, the communication module is operable to transmit data related to the captured at least one image and the determined felling location of the log to the remote server arrangement. Throughout the present disclosure, the term “communication module” relates to an arrangement of interconnected programmable and/or non-programmable components that are configured to facilitate data communication between one or more electronic devices (namely the at least one imaging device and the remote server arrangement), whether available or known at the time of filing or as later developed. Furthermore, the communication module may include, but is not limited to, one or more peer-to-peer network, a hybrid peer-to-peer network, local area networks (LANs), radio access networks (RANs), metropolitan area networks (MANS), wide area networks (WANs), all or a portion of a public network such as the global computer network known as the Internet, a private network, a cellular network and any other communication system or systems at one or more locations. Additionally, the communication module includes wired or wireless communication that can be carried out via any number of known protocols, including, but not limited to, Internet Protocol (IP), Wireless Access Protocol (WAP), Frame Relay, or Asynchronous Transfer Mode (ATM). Moreover, any other suitable protocols using voice, video, data, or combinations thereof, can also be employed. The communication module is configured to operate within and/or peripherally with the at least imaging device. Furthermore, the communication module is configured to encrypt the data related to the captured at least one image and the determined felling location of the log to the remote server arrangement. Optionally, the communication module is operable to establish the connection between the at least one imaging device and the remote server arrangement via the Internet. Moreover, the at least one imaging device is operable to communicate the information to the remote server arrangement after the connection between the at least one imaging device and the remote server arrangement via the Internet is established. Additionally, in the event wherein the connection between the at least one imaging device and the remote server arrangement is not established the information is not sent, and is queued to be sent to the remote server arrangement after the connection via the Internet is established.

The arrangement comprises the remote server arrangement operable to receive data related to the captured at least one image and the determined felling location of the log. Throughout the present disclosure, the term “remote server arrangement” relates to a structure and/or module that include programmable and/or non-programmable components configured to store, process and/or share information related to the log. Optionally, the remote server arrangement includes any arrangement of physical or virtual computational entities capable of enhancing information to perform various computational tasks. Furthermore, it should be appreciated that the remote server arrangement may be both single hardware server and/or a plurality of hardware servers operating in a parallel or distributed architecture. In an example, the remote server arrangement may include components such as memory, a processor, a network adapter and the like, to store, process and/or share information with other computing components, such as user device/user equipment. Optionally, the remote server arrangement can be implemented as a computer program that provides various services (such as database service) to other devices, modules or apparatus. The remote server arrangement, via the communication module, receives data related to the log from the at least one imaging device. The data includes the entered metadata, at least a weight or a length of the log, at least one image, or felling location, namely the geographical coordinates of the felling location of the log. Furthermore, the remote server arrangement includes any sequence of instructions and/or one or more routines to process the received data.

Furthermore, the remote server arrangement is operable to process the received data to create the identification information for the log. Specifically, the sequence of instructions and/or one or more routines, executed upon the processor of the remote server arrangement are operable to create the identification information for the log from the received data of the log. Optionally, the remote server arrangement is operable to associate the entered metadata with the identification information for the log. Optionally, the remote server arrangement is operable to associate the measured at least weight or the length with the identification information for the log. Moreover, the at least one image of the log, and the felling location of the log is associated with the identification information for the log. In an example, the at least one imaging device may capture at least one image of the log “A” including an image of the stump of felled tree and image of the one or more end faces of the log. In such example, the image of the stump of felled tree and an image of the one or more end faces of the log may include one or more unique identification marks. In such example, the one or more unique identification mark may include specific scars in the end face of the log “A” made by the saw blade while cutting the tree, defects like knots and clefts on the end face of the log “A”, the pattern of annular rings on the stump of the fell tree and the end faces of the log “A”. Furthermore, in such example, metadata associated to the log “A” may be felling area's owner information of the log “A”, felling contractor company's information of the log “A”, log buyer information of the log “A” and log receiver information of the log “A”. In such example, the weight of the log “A” may be “J kgs” and the length of the log “A” may be “I meters”. Furthermore, in such example, the felling location of the log “A” may include GPS coordinates of the felling location of the log “A”, such as 01° 27′13.2″N 2° 20′21.0″E. In such example, the sequence of instructions and/or one or more routines executed upon the processor of the remote server arrangement may be configured to store, the image of the stump of felled tree form which the log “A” is formed and the image of the one or more end faces of the log “A” including the one or more unique identification marks, the metadata associated to the log “A”, GPS coordinates of the felling location of the log “A”, as the identification information for the log “A”.

The arrangement comprises the data processor that is operable to check if a query matches with the identification information in the remote server arrangement. Throughout the present disclosure, the term “data processor” relates to a computational element that is operable to respond to and processes instructions that drive the arrangement. Optionally, the processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. The data processor is operable to receive queries form the at least one imaging device. The queries as used herein refer to an image of a wood, preferably an end face of a piece of log. Furthermore, the queries can be generated by the users using the imaging device, namely the smartphone camera. In an example, the user may be any one of log buyer, log receiver, felling area's owner, using the user interface provided in the at least one imaging device, namely, the smartphone camera. In such example, the user may use the smartphone camera to capture an image of a wood, and thereafter use the captured image of the wood as a query.

Optionally, the data processor is operable to check if a queried image matches with the captured at least one image in the remote server arrangement. Optionally, the data processor is operatively coupled to the remote server arrangement. Therefore, the data processor is operable to retrieve the captured at least one image from the remote server arrangement. Furthermore, the data processor can include one or more algorithms that is operable to compare the queried image with the at least one image retrieved from the remote server arrangement. It will be appreciated that the queried image is the image of the wood captured using the smartphone camera and communicated to the data processor. Furthermore, in the event wherein the queried image matches with the captured at least one image in the remote server arrangement, the at least one image is determined as the matched image. Furthermore, the data processor is operable to retrieve identification information corresponding to the matched image. Optionally, the data processor includes collection or set of instructions that is operable to acquire the identification information associated with the at least one image of the log stored in the remote server arrangement that corresponds to the matched image. In an example, queried image may match with the captured at least one image of log “A”. Therefore, the retrieved identification information may be the image of the stump of felled tree form which the log “A” is formed and the image of the one or more end faces of the log “A” including the one or more unique identification marks, GPS coordinates of the felling location of the log “A” and the metadata associated with the log “A”. In such example, the metadata associated with the log “A” may include the one or more of felling area's owner information, felling contractor company's information, log buyer information and log receiver information.

The data processor is operable to determine if quality of the queried image exceeds quality of the matched image. For this purpose, the data processor includes one or more algorithms to determine the quality of the queried image. Moreover, the one or more algorithms are operable to compare the quality of the queried image with the matched image. Optionally, the one or more algorithms are operable to determine blur values of the queried image and the matched image. Furthermore, the one or more algorithms compare the blur values of the queried image and the matched image. In such event, the one or more algorithms determine if the blur values of the queried image exceed the quality of the matched image. For example, the blur value of the queried image is “G” and the blur value of the matched image is “H”. In such example, the one or more algorithms determine if the “G” is less than “H”. Therefore, if blur value of “G” is less than “H”, then it may be established that the quality of the queried image exceeds the quality of the matched image.

The data processor is operable to replace the captured at least one image with the queried image, if quality of the queried image exceeds quality of the matched image. In an example, the blur value of the queried image is “G” and the blur value of the matched image is “H”. In such example, the one or more algorithms determine if the “G” is less than “H”. In such example, if blur value “G” is less than blur value “H”, then the quality of the queried image exceeds the quality of the matched image. In such example, the data processor may be operable to replace the matched image store in the remote server arrangement with the queried image received at the data processor.

Optionally, the queries received at the data processor can include preferred felling area's owner information, preferred felling contractor company's information, preferred log buyer information, preferred log receiver information and a geographical felling location of the log. Beneficially, such queries may be operable to perform the efficient matching of the log and efficient retrieving of the identification information form the remote server arrangement. Optionally, the data processor may include set of instruction to perform the retrieval function, and provide information such as, any and all cost associated with the log. Beneficially, such set of instructions can be executed to automatically determine any changes associated with the log. Optionally, the remote server arrangement can include a set of instructions operable to associate the any and all cost associated with the log to the at least one image of the log. In an example, the set of instructions may form a module to be hosted by the programmable components of the remote server arrangement. Furthermore, the set of instruction may be operable to automatically provide the cost associated with the log. In such example, the user can be directly billed for a log against the queried image provided therein, that matches the at least one image including the identification information.

Optionally, the remote server arrangement can include a logical module that is operable to analyze the identification information for the log. Specifically, the logical module includes an algorithm that is operable to analyze the identification information for the log. In an example, the algorithm may be an artificial intelligence algorithm. In such example, the artificial intelligence algorithm, hosted by the remote server arrangement, may be operable to perform machine learning. Furthermore, the machine learning may enable the logical module to automatically analyze the identification information for the log. In such example, the artificial intelligence algorithm may be operable to inspect the identification information associated with the logs. Furthermore, the artificial intelligence algorithm may be operable to determine any possible relation within the identification information associated with the logs. In such example, the artificial intelligence algorithm may be operable to identify a trend by analyzing the identification information for the log. In such example, the trend may be identified based on the one or more unique identification marks, namely the annular rings formed on the stump of felled tree and/or the one or more end faces of the log associated to a specific felling location/geographical location. In such example, the artificial intelligence algorithm may be operable to automate the process of inclusion or determination of the felling location/geographical location associated with logs. Consequently, the artificial intelligence algorithm may be operable to optimize the arrangement for identification and tracking of a log. In such example, the remote server arrangement may be operable to provide additional information along with identification information of a log for the queried image received at the data processor. In such example, the additional information may be data related to the log, such as weight or length of other logs having the same felling location/geographical location as the log associated to the queried image.

### DETAILED DESCRIPTION OF THE DRAWINGS

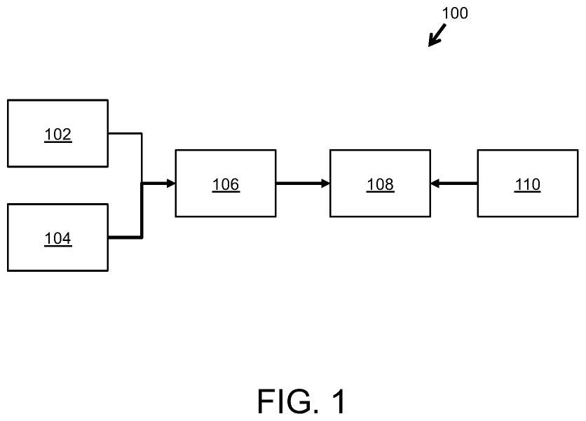

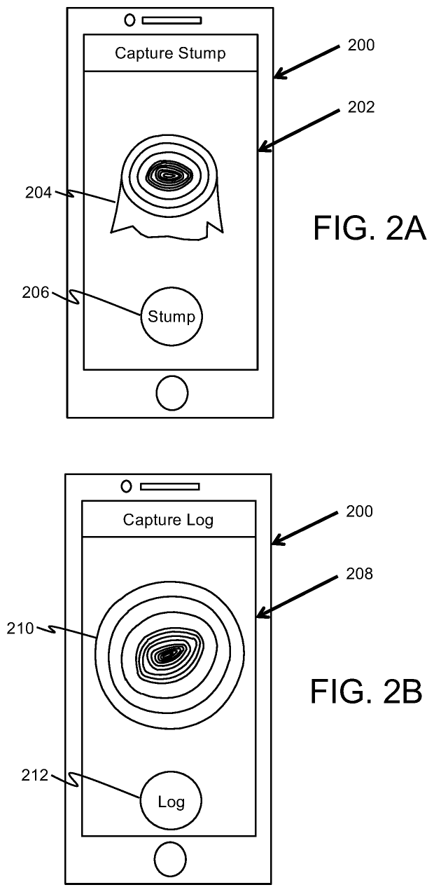

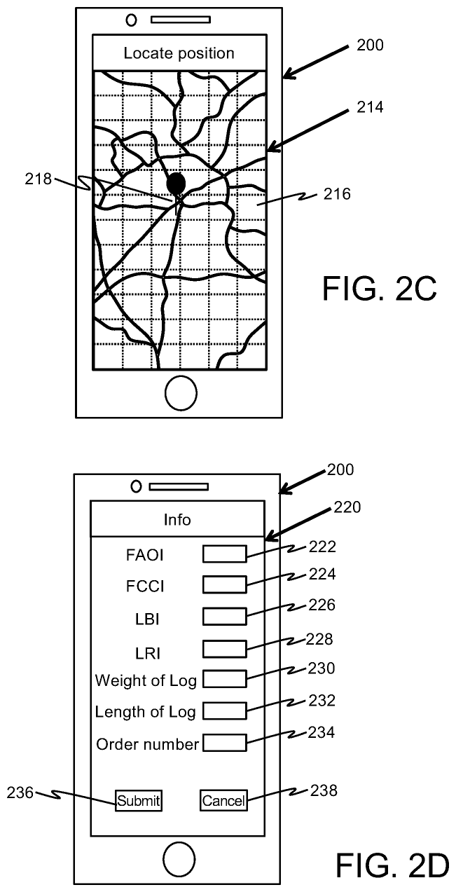

Referring to FIG. 1, there is shown a block diagram of an arrangement 100 for identifying and tracking a log, in accordance with an embodiment of the present disclosure. As shown, the arrangement 100 includes the at least one imaging device 102, a Global Positioning System (GPS) receiver 104, a communication module 106, a remote server arrangement 108, and a data processor 110. Herein, the communication module 106 is operable to transmit data, (for example, captured at least one image, metadata associated to the at least one image, and the like) from the at least one imaging device 102 and the determined felling location of the log from the Global Positioning System (GPS) receiver 104, to the remote server arrangement 108. In one example, the at least one imaging device 102 and the Global Positioning System (GPS) receiver 104 are implemented in a smartphone (such as the smartphone 200 shown in FIGS. 2A-2D described later). Moreover, the data processor 110 is communicably coupled with the remote server arrangement 108. Furthermore, the data processor 110 is operable to acquire the identification information from the remote server arrangement 108. Moreover, the data processor 110 is operable to replace the at least one image stored in the remote server arrangement 108.

Referring to FIGS. 2A-2D, there are shown the schematic illustrations of exemplary graphical user interfaces for implementing the arrangement 100 for identifying the log, in accordance with an embodiment of the present disclosure. As shown, the exemplary graphical user interfaces 202, 208, 214 and 220 are displayed on a smartphone 200.

Referring to FIG. 2A, the exemplary graphical user interface 202 includes a graphical element 204 and a graphical element 206. The exemplary graphical user interface 202 is used for capturing an image of stump of felled tree. Furthermore, the graphical element 204 is the image of stump of felled tree captured by the at least one imaging device (such as the at least one imaging device 102 of FIG. 1) included in the smartphone 200. Moreover, the graphical element 206 is a graphical button that is used for capturing the image of stump of felled tree via the at least one imaging device (such as the at least one imaging device 102 of FIG. 1) included in the smartphone 200.

Referring to FIG. 2B, the exemplary graphical user interface 208 includes a graphical element 210 and a graphical element 212. The exemplary graphical user interface 208 is used for capturing an image of log. Furthermore, the graphical element 210 is the image of an end face of the log captured by the at least one imaging device (such as the at least one imaging device 102 of FIG. 1) included in the smartphone 200. Moreover, the graphical element 212 is a graphical button that is used for capturing the image of the end face of the log separated from the stump of felled tree associated with the graphical element 204 (as shown in the exemplary graphical user interfaces 202 of FIG. 2A).

Referring to FIG. 2C, the exemplary graphical user interface 214 includes a graphical element 216 and a graphical element 218. The exemplary graphical user interface 214 is used to display a felling location of the log. Furthermore, the graphical element 216 is a graphical display of a map of the geographical area of the felling location of the log. Moreover, the graphical element 218 identifies the geographical coordinates of the Global Positioning System (GPS) receiver. For example, the graphical element 218 identifies the geographical coordinates of the smartphone 200 that include the Global Positioning System (GPS) receiver (such as the Global Positioning System (GPS) receiver 104 of FIG. 1).

Referring to FIG. 2D, the exemplary graphical user interface 220 displayed in the smartphone 200 includes input field (such as input fields 222 to 230) for entering the metadata associated with the log. The input field 222 enables the acquiring of felling area's owner information (FAOI). The input field 224 enables the acquiring of felling contractor company's information (FCCI). The input field 226 enables the acquiring of log buyer information (LBI). The input field 228 enables the acquiring of log receiver information (LRI). The input field 230 enables the acquiring of order number associated with the log. The order number associated with the log can comprise metadata including weight of the log, length of the log, type of wood associated with the log, quality of the log and so forth. Moreover, the exemplary graphical user interface 220 includes a graphical element 232, namely a “Submit” graphical button that can be used to save the metadata associated with the log entered via the input fields 222 to 230. Furthermore, the metadata associated with the log entered via the input fields 222 to 230 and saved using the graphical element 232 can be stored in a memory (not shown) of the smartphone 200. Additionally, the exemplary graphical user interface 220 includes a graphical element 234, namely a “Cancel” graphical button that can be used to reject the metadata associated with the log entered via the input fields 222 to 230.

The graphical element 204, 210, 218, of the exemplary graphical user interfaces 202, 208, 214, and the metadata associated with the log entered via the input fields 222 to 230 of the exemplary graphical user interfaces 220, is used to form the identification information that can be used to identifying the log.

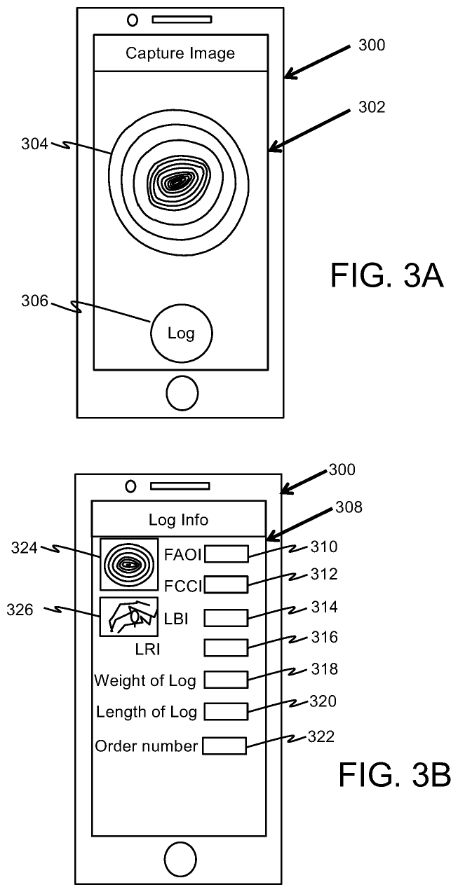

Referring to FIGS. 3A-3B, there are shown the schematic illustrations of exemplary graphical user interfaces for implementing the arrangement 100 for tracking the log, in accordance with an embodiment of the present disclosure. As shown, exemplary graphical user interfaces 302 and 308 are displayed on a smartphone 300. Optionally the smartphone 300 and the smartphone 200 of FIGS. 2A-2D may be the same smartphone.

Referring to FIG. 3A, the exemplary graphical user interface 302 includes a graphical element 304 and a graphical element 306. The exemplary graphical user interface 302 is used for capturing a queried image. The queried image may be an image of a wood, preferably an end face of a piece of log. Moreover, the graphical element 306 is a graphical button that is used for capturing the queried image via an imaging device associated with the smartphone 300.

Referring to FIG. 3B, the exemplary graphical user interface 308 includes information display fields (such as information display fields 310 to 322), and a graphical element 328 and a graphical element 330. The information display field 310 provides the acquiring of felling area's owner information (FAOI). The information display field 312 provides the acquiring of felling contractor company's information (FCCI). The information display field 314 provides the acquiring of log buyer information (LBI). The information display field 316 provides the acquiring of log receiver information (LRI). The information display field 320 provides the acquiring of the length of the log. The information display field 322 provides the acquiring of the type of wood associated with the log. The information display field 324 provides the acquiring of quality of the log. The information display field 326 provides the acquiring of order number associated with the log. Moreover, the graphical element 328 is the image, namely the matched image, of the end face of the log (such as the graphical element 210 of FIG. 2B) and the the graphical element 330 is the image of the felling location of the log (such as the graphical element 218 of FIG. 2C). The information display fields 310 to 322, and the graphical element 328 and the graphical element 330 are adapted to provide the aforesaid information on the exemplary graphical user interface 308 in the event wherein the queried image captured using graphical element (such as the graphical element 306 of FIG. 3A) matches with the captured at least one image (such as the graphical element 210 of FIG. 2B) stored in the remote server arrangement (such as the remote server arrangement 108 of FIG. 1).

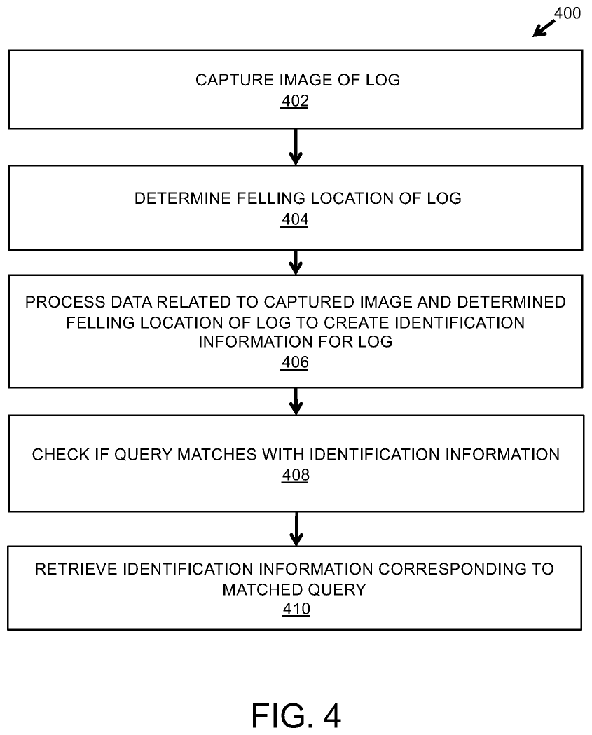

Referring to FIG. 4, there are shown steps of a method 400 of identifying and tracking a log, in accordance with an embodiment of the present disclosure. At a step 402, at least one image of the log is captured. At a step 404, a felling location of the log is determined. At a step 406, data related to the captured at least one image and the determined felling location of the log are processed to create identification information for the log. At a step 408, a query matches with the identification information is checked. At a step 410, identification information corresponding to the matched query is retrieved.

The steps 402 to 410 are only illustrative and other alternatives can also be provided where one or more steps are added, one or more steps are removed, or one or more steps are provided in a different sequence without departing from the scope of the claims herein. In one example, the method further comprises checking if a queried image matches with the captured at least one image, and retrieving identification information corresponding to the matched image. In another example, the method further comprises receiving metadata about the log, and associating the received metadata with the identification information for the log. In another example, the method further comprises measuring at least a weight or a length of the log, and associating the measured at least weight or the length with the identification information for the log. In another example, the at least one image comprises an image of stump of felled tree. In another example, the at least one image comprises an image of one or more end faces of the log. In another example, the method further comprises acquiring calibration information of an imaging device used for capturing at least one image of the log with respect to a planar surface of the log, and constructing a corrected image of the log using the calibration information. In another example, the method further comprises zooming on an end face of the log for capturing at least one image thereof. In another example, the method further comprises checking if quality of the at least one image is below predefined parameters. In another example, the method further comprises generating a signal to indicate to a user to capture at least one new image of the log, if quality of the at least one image is below predefined parameters, and replacing the at least one image of the log with the at least one new image of the log. In another example, the method further comprises determining if one or more other images of the log are available, and combining one or more other images of the log with the at least one image of the log to generate a corrected image of the log. In another example, the method further comprises determining if quality of the queried image exceeds quality of the matched image, and replacing the captured at least one image with the queried image, if quality of the queried image exceeds quality of the matched image.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1.-26. (canceled)

27. An arrangement (100) for identifying and tracking a log, wherein the arrangement comprises:
at least one imaging device (102) operable to capture at least one image of the log and at least one image of a stump of a felled tree;
a Global Positioning System (GPS) (104) receiver operable to determine a felling location of the log;
a remote server arrangement (108) operable to receive data related to the captured at least one image of the log, the at least one image of the stump and the determined felling location of the log, and process the received data to create an identification information for the log; and
a data processor (110) that is operable to check if a queried image matches with the identification information in the remote server arrangement (108), and retrieve identification information corresponding to the matched queried image, wherein the data processor (110) is operable to:
determine if a quality of the queried image exceeds a quality of the matched image; and
replace the captured at least one image with the queried image, if the quality of the queried image exceeds the quality of the matched image.

28. An arrangement of claim 27, wherein the data processor (110) is operable to check if the queried image matches with the captured at least one image in the remote server arrangement (108), and retrieve identification information corresponding to the matched image.

29. An arrangement of claim 27, wherein the arrangement further comprises at least one input arrangement operable to enter metadata about the log, wherein the remote server arrangement (108) is operable to associate the entered metadata with the identification information for the log, wherein the entered metadata includes one or more of felling area's owner information, felling contractor company's information, log buyer information and log receiver information.

30. An arrangement of claim 27, wherein the arrangement further comprises at least one sensor operable to measure at least a weight or a length of the log, wherein the remote server arrangement (108) is operable to associate the measured at least weight or the length with the identification information for the log.

31. An arrangement of claim 27, wherein the arrangement further comprises a communication module operable to transmit data related to the captured at least one image and the determined felling location of the log to the remote server arrangement (108).

32. An arrangement of claim 27, wherein the at least one image comprises an image of one or more end faces of the log.

33. An arrangement of claim 27, wherein the at least one imaging device (102) comprises a smartphone camera.

34. An arrangement of claim 27, wherein the at least one imaging device (102) comprises a camera mounted on a forest harvester.

35. An arrangement of claim 33, wherein the at least one imaging device (102) comprises a microwave imaging device.

36. An arrangement of claim 34, wherein the at least one imaging device (102) comprises a microwave imaging device.

37. An arrangement of claim 27, wherein the at least one imaging device comprises a tilt orientation support module operable to:
acquire calibration information of the least one imaging device with respect to a planar surface of the log; and
construct a corrected image of the log using the calibration information.

38. An arrangement of claim 27, wherein the at least one imaging device (102) comprises an image checking module operable to check if quality of the at least one image is below predefined parameters.

39. . A method of identifying and tracking a log, wherein the method comprises:
capturing at least one image of the log and at least one image of a stump of a felled tree;
determining a felling location of the log;
processing data related to the captured at least one image of the log, the at least one image of the stump and the determined felling location of the log to create an identification information for the log;
checking if a queried image matches with the identification information; and
retrieving identification information corresponding to the matched queried image, wherein the step of checking a queried image comprises:
determining if quality of the queried image exceeds quality of the matched image; and
replacing the captured at least one image with the queried image, if quality of the queried image exceeds quality of the matched image.

40. A method of claim 38, wherein the method further comprises:
checking if the queried image matches with the captured at least one image; and
retrieving identification information corresponding to the matched image.

41. A method of claim 39, wherein the method further comprises:
receiving metadata about the log; and
associating the received metadata with the identification information for the log.

42. A method of claim 38, wherein the method further comprises:
measuring at least a weight or a length of the log; and
associating the measured at least weight or the length with the identification information for the log.

43. A method of claim 38, wherein, in the method, the at least one image comprises an image of one or more end faces of the log.

44. A method of any one of claims 39, wherein the method further comprises:
acquiring calibration information of an imaging device used for capturing at least one image of the log with respect to a planar surface of the log; and
constructing a corrected image of the log using the calibration information.

45. A method of any one of claims 38, wherein the method further comprises checking if quality of the at least one image is below predefined parameters.

46. A computer readable medium containing program instructions for execution on a computer system, wherein the program instructions when executed by the computer system cause the computer system to perform steps of a method of (for) identifying and tracking a log, wherein steps of the method comprise:
capturing at least one image of the log and at least one image of a stump of a felled tree;
determining a felling location of the log;
processing data related to captured at least one image of the log, the at least one image of the stump and the determined felling location of the log to create an identification information for the log.
